(19) United States
(12) Patent Application Publication
(10) Pub. No.: US 2006/0046698 A1
(43) Pub. Date: Mar. 2, 2006

(54) Telephony service system

(75) Inventor: John Thomas O'Brien, North Sydney, NSW (AU)

Correspondence Address: VOLPE AND KOENIG, P.C., UNITED PLAZA, SUITE 1600, 30 SOUTH 17TH STREET, PHILADELPHIA, PA, 19103, US

(73) Assignee: Endmell Pty. Ltd., North Sydney, New South Wales (AU)

(21) Appl. No.: 10/537,423

(22) PCT Filed: Dec. 9, 2003
(86) PCT No.: PCT/AU03/01625

§ 371 Date: Jun. 2, 2005

(30) Foreign Application Priority Data
Dec. 9, 2002 (AU) 2002953210

(51) Int. Cl. H04M 11/10

(52) U.S. Cl. 455/413

(57) ABSTRACT

A method of automatically allocating a mailbox to a called party in a digital telephone network, including the steps: receiving a call to be routed to a called party; extracting one or more relevant predefined parameters from the call; using one or more of the extracted parameters to determine the existence of a mailbox associated with the called party; if an associated mailbox exists, translating the call to that mailbox address; if there is not a mailbox associated with the called party, allocating a mailbox from a pre-existing pool of mailboxes available for allocation to the called party; diverting the call to the allocated mailbox.

### BACKGROUND OF THE INVENTION

This invention relates to a telephony service system. It is particularly directed to control of message boxes for mobile telecommunications but is not limited to such use.

A telephony service system enables a person calling to use a telecommunication device such as a land line telephone, personal computer or mobile telephone connected to the system to exchange information, whether that is voice, text, video or data with a called party also using a telecommunication device connected to the system. However the called party is often unable to receive the information if not there or because the line is busy.

Several solutions to this problem have been developed. Perhaps the most common solution at the present time is to utilise a voice mailbox service which the called party can later access.

A mailbox is a medium or device (such as magnetic tape or random access memory) in which information can be stored and accessed. A service provider (such as a local exchange carrier) stores information from calling parties when the called party is unable to participate in the exchange of information. The called party, at some convenient time, can then access the voice mailbox (for example, by dialling a special telephone number and using a password) to receive the information.

This solution, however, depends on the called party making provisions for receiving information when the called party is unavailable or unwilling to participate in the exchange of information.

Conventionally, message mailbox systems have been deployed either by preestablishing mailboxes for all prospective users or by establishing mailboxes for users as they subscribe to the messaging service. However, pre-establishment requires investment in a large system capacity and also results in a large database, the repetitive searching of which results in an overall downgrading of system performance. This situation is exacerbated when many of the mailboxes are unused.

There was a perceived need for a service for enabling a person calling to make information available to a called party when the called party has not made such provisions.

There have been some solutions to meet that need that were proposed in patent applications. These disclosures are not considered to be well known or even in use but are raised here to more clearly delineate the present invention.

In European Patent Application No. EP 782,314 there is disclosed a called party mailbox service where the service establishes a called party mailbox (CPMB) for a specified duration of time upon request of a calling party when a called party is unable or unwilling to respond to the calling party. The CPMB service permits a CPMB to be accessed by a called party and permits a CPMB to be modified by authorized users. The status of access information is available to the calling party, which access information characterizes the extent of access to the established mailbox by the called party. The CPMB is advantageously implemented by a CPMB control system comprising a processor and memory, which CPMB control system is connected to a communications network.

European Patent Application No. EP 838,935 discloses an on demand mailbox creation for messaging systems wherein a messaging system has a memory device, an external interface, and a controller coupled to the memory device and the external interface. If the controller receives a message from a person calling for a called party through the external interface, and the called party does not have a mailbox, then the controller creates a “called party mailbox” and stores the message in the called party mailbox. After saving the message in the called party mailbox, the controller alerts the called party of the existence of a message saved in the called party mailbox. The called party can call the messaging system to retrieve a message stored in the called party mailbox and can also send a reply message to the person calling. A mailbox will also be created for calling parties who wish to send store and forward messages to called parties. The messaging system provides calling parties with the ability to send or leave a message for any called party irrespective of whether the called party is a customer of the messaging service.

Japanese Patent Document JP 7177235 discloses a system to automatically generate a mail box for a user in a voice mail device only when the user of the voice mail device requires the mail box. When the user calls the voice mail device, an information reception analytic part receives and analyses a voice message storage request from the user and the extension number of the destination user of a voice message and sends them to an automatic mail box generation part. The automatic mail box generation part is requested so as to generate the mail box with a specified mail box recognition code unless a mail box having the same mail box recognition code is present in a mail box storage part. The automatic mail box generation part generates the new mail box in the mail box storage part with the received mail box recognition code. A voice message storage control part stores the voice message from the user in the mail box specified with the mail box recognition code.

In U.S. Pat. No. 6,097,791 there is disclosed a voice messaging system with non-user outcalling and auto-provisioning capabilities including an automatic means for configuring a telephone number to become a subscriber to a voice messaging service. The voice messaging system described therein facilitates the process of acquiring a voice mailbox by providing non-user outcalling and auto-provisioning. A voice messaging service user will be able to send a non-user voice messages using the voice messaging service, and, the non-user recipient desiring to subscribe to voice mailbox service can acquire a voice mailbox simply by responding to interactive queries after the reception of the voice message. The system also automatically establishes call forwarding at the appropriate central office switch and automatically creates a voice mailbox at the voice messaging system if a non-user recipient desires to become a subscriber to the voice messaging system.

European Patent Application EP 840,491 discloses a method and apparatus for dynamically creating message mailboxes with a system that dynamically creates a mailbox if the mailbox does not exist for a message at the time that the message is to be stored when dynamic mailbox creation is enabled. A system level process indicates that the mailbox exists and provides default subscriber information to a voice messaging application during the receipt of a message when a mailbox does not exist on the system for the recipient of the message and dynamic mailbox creation is enabled. At the time the message is to be stored, the mailbox is created with the default subscriber information. The system checks for erroneous mailboxes by requesting confirmation of the recipient telephone number from the telephone system using a message waiting indication packet. This check can be performed before the mailbox is created when the mailbox address is available, while the message is being held before being stored, or it can be used to delete the mailbox after it is created. When the message is retrieved, the mailbox is initialized. Mailboxes that are not initialized and that are dynamically created are deleted after a mailbox expiration time period has elapsed

Also, European Patent Application EP 1,185,068 discloses method and apparatus for voice messaging originated by mobile terminals wherein an apparatus and method for transmission of information over an electronic network in the form of a user-to-user voice messaging service between mobile phone subscribers. A voice SMS system provides a handset interface layer coupled with a graphics user interface (GUI), mobile terminated SMS notifications and an interface for the utilization of the Personal Address Book (PAB) of the message sender to address messages. The interface layer manages both incoming and outgoing voice messages.

It can therefore be seen that the prior art located discloses methods that create a new mailbox where none is associated with a called party. Some methods then delete the mailbox in certain circumstances; such as if it is not used, etc.

The major problem with the prior art is that the creation of a voice mailbox on an operational system takes time. In the real-time processing required of a carrier grade voice-mail system, the time taken to create a voice mailbox can result in the person calling hanging-up before the creation is completed. Any delay in the creation of the voice-mailbox results in the person calling having to wait before they deposit their message.

The waiting period on an operational voice mail system, depends on load, but could be tens of seconds. This would likely mean that the system does not meet the quality of service (QoS) standards required by the carrier.

### SUMMARY OF THE INVENTION

Broadly in accordance with the invention there is provided a method of automatically allocating a mailbox to a called party in a digital telephone network, including the steps:
receiving a call to be routed to a called party;
extracting one or more relevant predefined parameters from the call;
using one or more of the extracted parameters to determine the existence of a mailbox associated with the called party;
if an associated mailbox exists, translating the call to that mailbox address;
if there is not a mailbox number associated with the called party, allocating a mailbox from a pre-existing pool of mailboxes available for allocation to the called party;
diverting the call to the allocated mailbox.

More specifically in accordance with the invention there is provided a method of automatically allocating a mailbox to a called party in a digital telephone network, including the steps:
receiving a call to be routed to a called party;
extracting one or more relevant predefined parameters from the call to identify the nature of the caller and the nature of the called destination including the called party's telephone number;
using one or more of the extracted parameters to examine a database, archive, information listing or the like to determine the existence of mailbox identifier associated with the called party;
if an associated mailbox exists, translating the called number to that mailbox address;
if the database does not contain a mailbox identifier associated with the called number, allocating a mailbox from a pre-existing pool of mailboxes available for allocation to the called party's telephone number;
diverting the call to the allocated mailbox;
notifying the called party of the waiting message.

The invention also may include the step of deleting the contents of the mailbox, de-allocating the mailbox and returning it to the pool of mailboxes available for allocation on the occurrence of any one of following events:
no message deposits and message retrievals have been made within a pre-defined period;
or no message deposits have been made within a pre-defined period; or
no message retrievals have been made within a pre-defined period.

In another aspect, the invention provides a method of maintaining a pool of mailboxes available for allocation, de-allocation and re-allocation, and thereby minimising the amount of required storage space for the said pool, including the steps:
at a predetermined time frequency, scanning a database of mailbox allocation and usage records;
from those records, detecting an allocated mailbox and determining its last usage time;
if the last usage time exceeds a predetermined period, deleting the contents of the mailbox and marking the mailbox as free for re-allocation;
continuing until all mailbox records have been scanned at which time the process is suspended until it conducts another cycle at the said predetermined time frequency.

The invention therefore includes the feature that a pool of pre-existing, un-allocated mailboxes and any allocated boxes that are not used are returned to the pool for reallocation.

The solution of the invention is different to the prior art as it has a pool of mailboxes (such as voice mailboxes) created, but not allocated to any specific mailbox owner. This is known as the pool of unallocated mailboxes.

When a call is received and a voice mailbox has not been assigned to an owner, instead of dynamically creating the voice mailbox, the invention an unallocated voice mailbox from the pool is assigned to the receiving party. The assignment of this pre-existing, but unassigned voice mailbox happens almost instantaneously. This process overcomes the inherent delay in dynamic voice mailbox creation.

Further, the prior art states that when a voice mailbox is no longer required it can be deleted. With the present invention, when a voice mailbox is no longer required, it is emptied of any remaining messages, and then returned to the pool of unallocated voice mailboxes. Thus insuring that the pool of unallocated voice mailboxes can be re-allocated as required and minimising the total number of mailboxes in the pool.

Similarly, mailboxes that are “permanently” allocated to subscribers can be subjected to the same or modified de-allocation rules according to the invention and thus be returned to the pool in specified circumstances. When a subscriber needs to use the messaging system again another box will be allocated from the pool according to the invention. By this process, a subscriber will receive the same level of service that would be provided by a permanently allocated mailbox but the overall number of mailboxes required to be maintained in the system will be minimised.

The aim of the invention is to reduce the overall number of voice mailboxes and hence license payments, required by carrier. This involved developing a “front-end” to the system. The front-end is located between the carrier's telephony switch and the voice-mail system. The reduction in the overall number of voice-mailboxes allows the carrier to seek a saving in the operational cost associated with operating their voice-mail system.

Further, the front-end system is designed to be generic for the purpose of depositing messages in the voice-mailbox, and independent of the model or supplier of voice-mail system.

The invention also discloses a method of dynamically allocating a mailbox to a called party in a digital telephone network, comprising the following steps:
receiving a call to be routed to a called party;
extracting relevant/predefined parameters from the message;
examining/inspecting a database as to the existence of an associated mailbox number translating the called number to a mailbox address, if available or, in the event that the called party does not have a mailbox/the database does not contain a mailbox number associated with the called number, assigning a mailbox to the called party telephone number;
diverting the call to the allocated mailbox.

The method can have the mailbox allocated to the called party from a pre-existing pool of mailboxes. The called party can be identified by a digital network telephone number/telephony network identifier or the method can have the mailbox identified by an identification number. However, the method of automatically associating a telephony network identifier/digital network telephone number is with a mailbox identification number.

The method of the automatic association/allocation process can be initiated in any one of the following events:
the called party does not answer the call;
the called mobile network subscriber/party does not have a mailbox;
and the call does not originate from the called party (under “Option A” herein).

The method of deleting the contents of the mailbox and de-allocating the mailbox can be on the occurrence of any one of following events:
no message deposits and message retrievals have been made within a pre-defined period; or
no message deposits have been made within a pre-defined period; or
no message retrievals have been made within a pre-defined period.

The method of de-associating the mailbox number from the subscriber identifier can also be on the occurrence of any of the above listed events.

The method includes returning the de-allocated mailbox to the pool of mailboxes available for re-allocation. The re-allocating of the mailbox can be to a new mobile network subscriber upon the occurrence of any of the events listed above

The method of maintaining and monitoring a plurality of mailboxes available for allocation, de-allocation and re-allocation can be maintenance and update of translation table. In particular there can be automatically associating, de-associating and re-associating mailbox identification numbers with digital network telephone numbers/telephony network identifiers. There can be a translating of a called party number to a pre-existing un-allocated mailbox number. The method of translating of a called party number can be to a pre-existing allocated mailbox number.

Prior to the commencement of operation an estimate is made of the maximum number of voice-mailboxes active at any one time. A pool of unallocated voice-mailboxes is created sufficiently large to accommodate the maximum number of voice-mailboxes active at any one time.

The invention is then installed within the operator's network. It is connected in such a manner that it is attached to the operators or carrier's telephony switch.

A person calling is making a call to a receiving party and the carrier's telephony switch determines that the call should be terminated in the voice-mail system in a voice-mailbox allocated to the receiving party. The invention is made aware of the progress of the call and will determine if an active voice-mailbox has been previously allocated to the receiving party. If this is the case, the person calling's call will be directed to terminate in the voice-mailbox allocated to the receiving party.

If this is not the case, then the invention will select an unallocated voice-mailbox from the pool of unallocated voice-mailboxes and associate this with the receiving party. The person calling's call will then be directed to terminate in the voice-mailbox just allocated to the receiving party.

Periodically the invention will scan the allocated voice-mailboxes and apply certain criteria to determine if voice-mailbox is no longer required to be allocated to a receiving party (parameters determined by the operator and configurable in production). If the voice-mailbox is no longer to be allocated to a receiving party, the association between the voice-mailbox and the receiving party is broken, and it is emptied of any remaining messages, and then returned to the pool for recycling. To reduce pool space, the system operator specifies a high/low water mark of mailboxes unallocated at any one time. In this way there is no need to populate the VMS to its capacity, but rather the system maintains a certain overhead of available pool mailboxes, which automatically grows/shrinks as usage requirements dictate.

The monitoring capabilities of voice-mail traffic are significantly enhanced by the invention. The invention incorporates statistics giving details of voice-mail utilisation and call traffic. This information will readily allow system planners and network engineers to assess the network traffic for planning purposes.

Carriers and operators have expressed a significant need for additional reporting capabilities on their voice-mail systems. The invention, due to the nature of its location in the network and how it works, provides the capability of enhanced reporting and call traffic analysis.

### DETAILED DESCRIPTION OF THE INVENTION

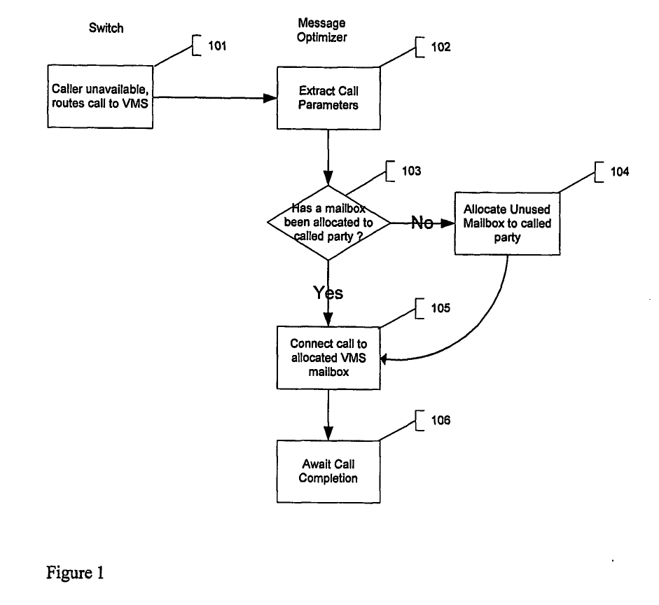

In order that the invention might be more readily understood an example of an embodiment is given by reference to the accompanying drawings. As shown in FIG. 1, the network telephony switch (external to the Message Optimiser™ System) (101) determines that the called party is not available for some reason, and determines to route the call to the voice mail system. The Message Optimiser (MO) extracts the called party details, and person calling details from the call message (102) and determines if the called party has previously been allocated a mailbox (103). If no mailbox has been allocated then a currently empty mailbox is allocated to the called party and the relevant database updated (104). The call is then connected to the allocated voice mail system mailbox (105) at which point the MO waits for notification of call completion (106).

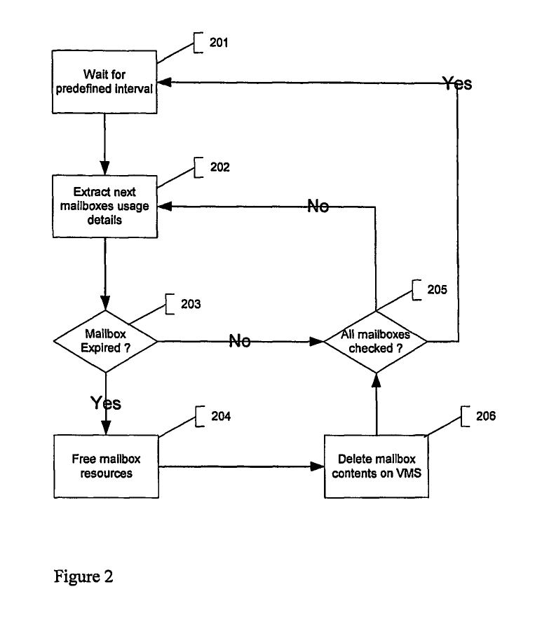

At a predefined period, configurable on a site specific basis, a process (201), as shown in FIG. 2, waits for the period to expire, and then commences a scan of all mailbox allocation and usage records (202) held within the MO database. A check is performed (203) against the last usage time for the mailbox, and if it exceeds a separate configurable period the mailbox is marked as free (204) within the database, and the existing mailbox contents are deleted from the VMS (206) creating an empty mailbox in its stead. This processing loop continues (205) until all mailbox usage entries have been examined, at which time the process returns to sleep for the initial predefined period (201).

By way of a further non-limiting example of an embodiment of the invention, the following is a detailed description of a functional specification for the MO system. Currently, voice-mail system providers charge carriers for the number of voice-mailboxes that they provide. Because a carrier generally must provide the service for all subscribers, it must maintain a mailbox for each subscriber, even though only approximately 30-40% of subscribers would use the service on a regular basis. This embodiment provides a solution to that where the MO creates a new service on the Telephony Service System (TSS) if one does not exist at the time of initial call processing, similar in concept to the way DHCP allocates limited IP numbers to computers on a network. Whilst voice-mailboxes are used in the example, the problem and its solution applies also to other telephony services.

The following implementation overview describes the functional requirements for the MO agent. It is intended that multiple Mobile Switching Centre (MSC) and TSS devices would be supported and are therefore referenced in generic terms and capabilities within this specification.

1 Implementation Overview

The Message Optimiser™ system can be deployed in various configurations. This would be dependant on the existing Voicemail configuration, geographical dispersion and the level of reporting information required.

Two options are shown below.

1.1 Option A

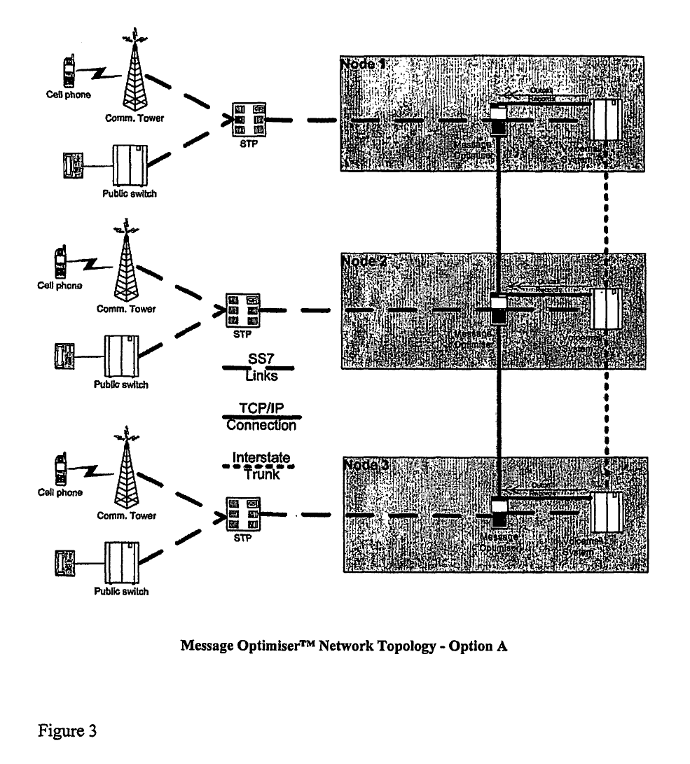

The Message Optimiser™ system is directly involved in the call path handling. As illustrated in FIG. 3, all calls to the voice mail system are routed to the Message Optimiser™ system, acting as an STP within the network, instead of directly to existing Voicemail System nodes.

Each voice mail installation site will have an instance of the Message Optimiser™ system. Each Message Optimiser™ system will be connected to any other Message Optimiser systems via a TCP/IP link to allow duplication of data. depicts an example network topology with voicemail nodes located in each state. This is an example only and the number of nodes would be interconnected similarly if expanded to eight or more nodes.

Each Message Optimiser will be connected to the local Voicemail System via a TCP link to allow for provisioning, mailbox deletion, and re-creation.

Each Message Optimiser™ server can be configured in redundant mode with the same point-code as another server to allow for load-sharing and fail-over redundancy if required.

1.2 Option B

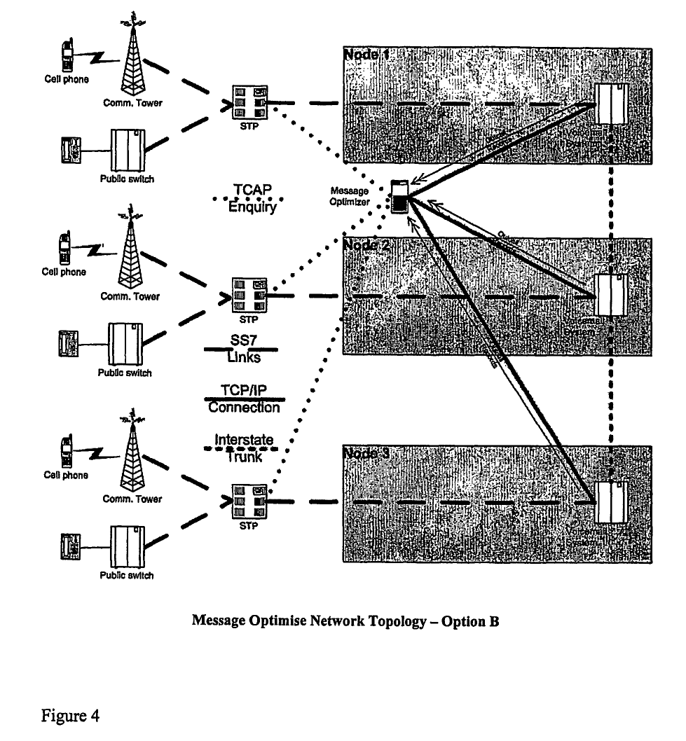

Shown in FIG. 4, the Message Optimiser™ system is utilized as an SCP or SDP within the network, providing a number translation service for translation of a voice mail target to a Voicemail System mailbox number.

Any call directed to a voice mail system, will cause the switching platform to trigger an address lookup/translation on the Message Optimiser™ system.

This option does not provide the same level of configuration and control as Option A, but removes the necessity to be closely involved in the call handling process. The feature list further down in this document provides more information on what cannot be supported with this option.

2 Function List

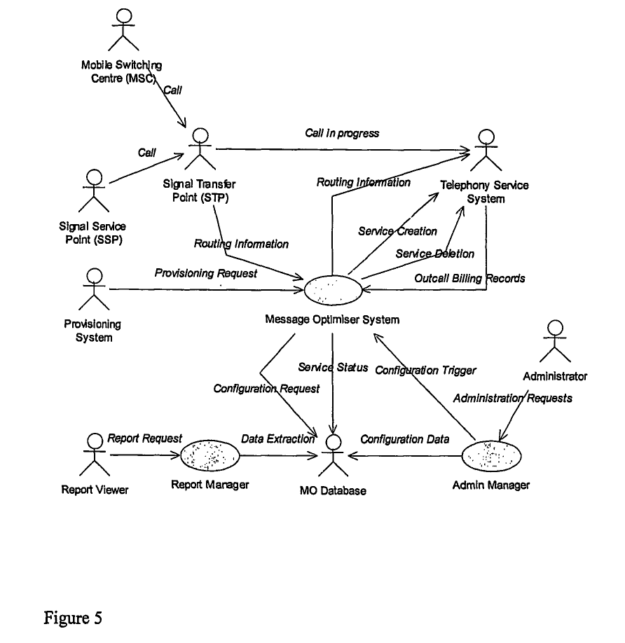

The Message Optimiser (MO), shown in overview in FIG. 5, receives call initiation messages from the Signal Transfer Point or Mobile Switching Centre (MSC) and determines what actions to perform with the call based on the call parameters.

The Message Optimiser may operate in two different methods within the telephone network. It may operate as a Signal Transfer Point (STP) where it handles call routing and setup, or it may operate as a Signal Data Point (SDP) where a request for an address translation is responded to from the STP.

The parameters extracted from the call information are compared against the MO database to determine whether the appropriate service exists on the Telephony Service System (TSS). A pool of available services is maintained on the TSS to allow for allocation of new services to a pre-allocated service on the TSS. If the service does not exist it is created on the TSS.

After completing the necessary transactions on the TSS and the MO Database, routing information is returned to the STP or MSC (if directly connected) to allow routing of the call to the TSS service, or to an appropriate error handling mechanism if the call information does not have appropriate service requirements.

The TSS may present Outcall records to the Message Optimiser to cater for TSS originated utilisation tracking by the MO.

Additionally, provisioning information may be passed to the MO to provide details necessary for MO to differentiate between varied called parties.

Report data are stored within the database, and may be viewed via the Report Manager.

Administration and configuration of the MO system is performed via the Admin Manager.

2 Service Status

The Service Status package outlines the interactions with the database necessary to determine the status of a particular service, and to provide statistics of call activity.

2.1.1 Determine Service Status

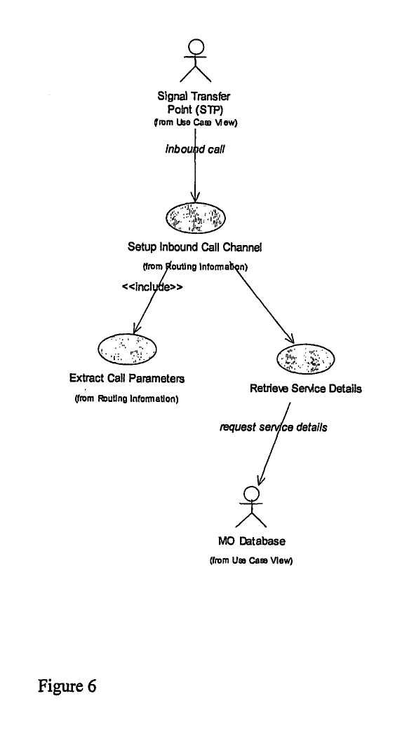

As shown in FIG. 6, the details necessary to determine the service are extracted from the inbound call's call parameters. From these parameters the necessary details to query the database for the service details are obtained.

If no details exist, a new record is added to the database provided that the call details fall within a set of limits necessary to create a new service. In this way, it is not necessary to pre-define all of the services and subscribers supported by a carrier.

2.2 Routing Information

The Routing Information package provides an overview of the requirements necessary to process call routing information.

2.2.1 Call Setup

The ambition of the call setup is to establish a communication pathway between the MSC and the appropriate TSS.

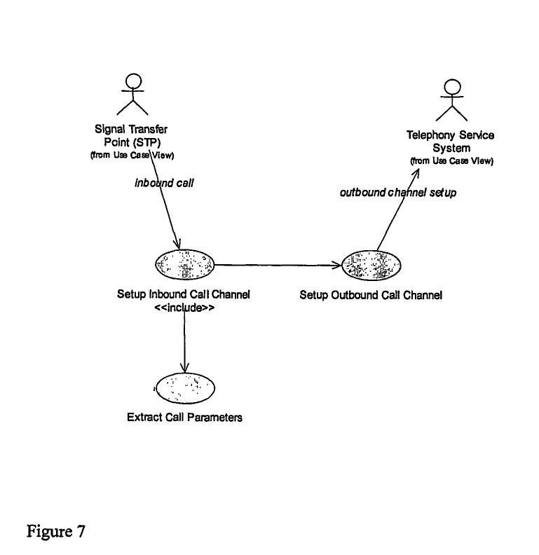

FIG. 7 shows a simple overview of the call-setup process only. The presumption in this diagram is that the service is already created on the TSS, or that it has been created as part of this process, but its detail is not depicted.

2.2.2 Call Teardown

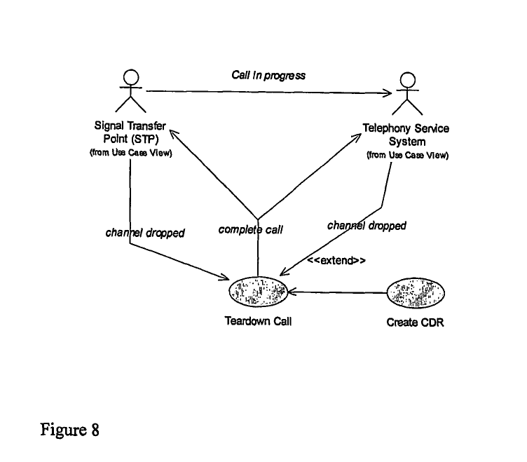

As shown in FIG. 8, a call can be broken via three means. The caller may terminate the call, the TSS may terminate the call, or there may be a network problem which terminates the call.

When the caller terminates the call the STP will forward information to the MO to advise that the call has been terminated. The MO must then advise the TSS of the necessary action to complete the call.

When the TSS terminates the call the TSS will forward information to the MO to advise that the call has been terminated. The MO must then advise the STP of the necessary action to complete the call.

A race condition may exist where both the caller and TSS terminate the call prior to receiving notification of termination of the other party. In this case the MO must handle call completion correctly.

On completion of a call the MO will perform any tidy up within itself, and lodge a CDR record to the CDR records for the system.

Call Detail Records (CDR) contain information about every call handled by the MO system.

2.2.3 Call Setup Option A

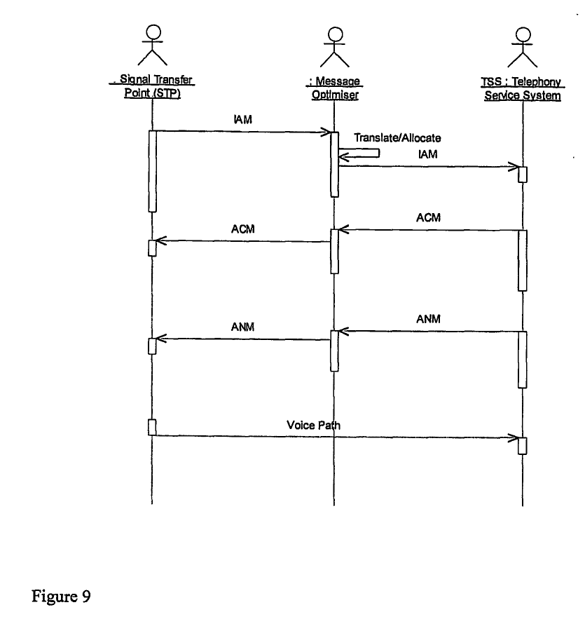

FIG. 9 depicts the SS7 ISUP call flow for call creation used by the mechanism termed “Option A” throughout this document.

The Initial Address Message (IAM) is received from the STP. The MO extracts the called party details from the IAM message and translates or allocates the TSS service number to the called party, forwarding an IAM to the TSS. This is the only interference in the normal ISUP call setup message flow.

Call Teardown

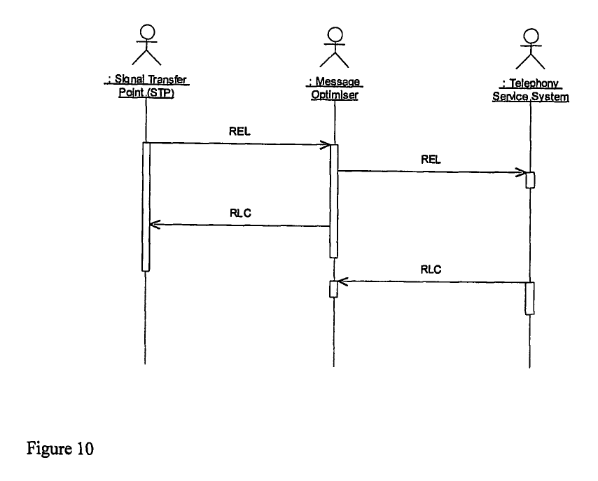

FIG. 10 depicts the SS7 ISUP call flow for both Option A and Option B where the caller terminates the call.

When the TSS terminates the call, the STP and TSS may be swapped, to achieve the correct message flow.

Where both parties terminate prior to receipt of the RLC message flow is duplicated in both directions.

Call Setup Option B

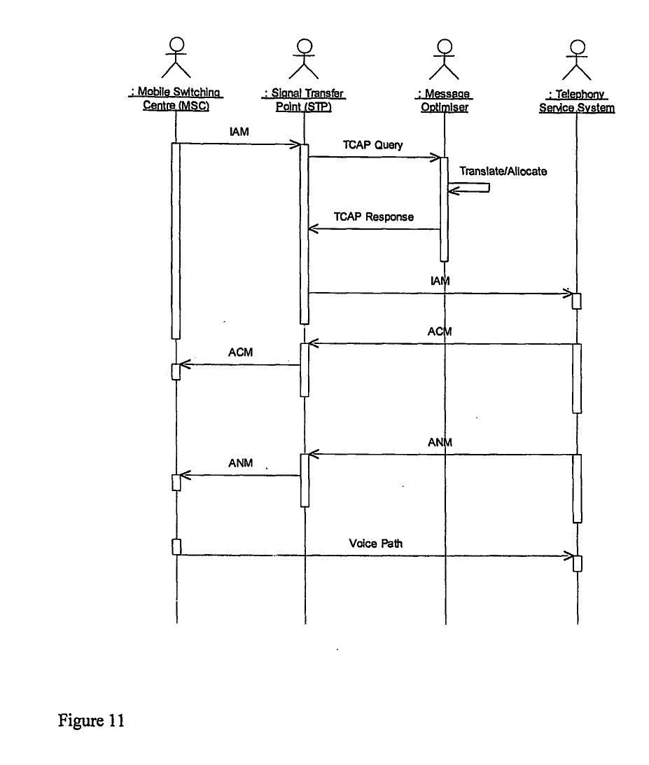

FIG. 11 depicts the SS7 message flow at both the ISUP and TCAP levels utilised by the mechanism termed “Option B” throughout this document.

When the STP receives the IAM it triggers a query to the Message Optimiser to request a translation and returns the address to the STP. Normal call flow follows from that point.

2.3 Service Creation

Service Creation provides an overview of the requirements to create services on various Telephony Service Systems (TSS).

2.3.1 Service Creation

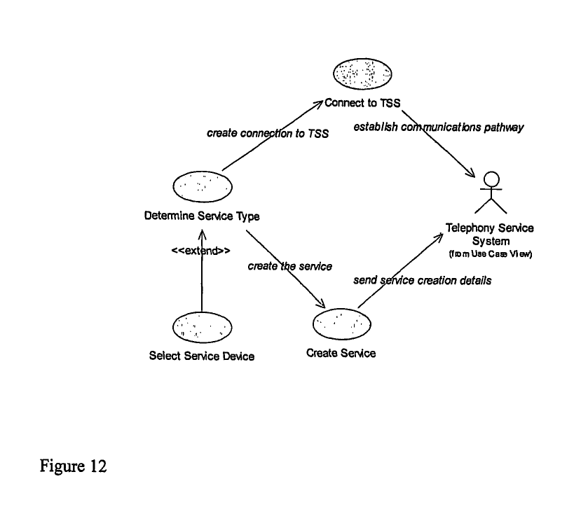

Service creation is illustrated diagrammatically I FIG. 12. If a service does not exist on a particular TSS it must be established prior to the call being routed to the TSS device.

Due to the inherent delays in creating a service on a TSS, the Message Optimiser maintains a pool of spare created services on the TSS and allocates new services from the pool. When a pool reaches a minimum available threshold, a number of new services are created an added to the pool. When the number of free services in the pool exceeds a configurable value, sufficient services are deleted from the system to maintain the pool within a configurable range.

Multiple service types and multiple devices per service type must be supported. This implies that multiple connection protocols must also be supported.

2.4 Provisioning Request

The Provisioning Request package is a site specific implementation to interpret requests for provisioning of TSS services extracting the necessary information that the Message Optimiser needs to configure the service, passing on any information that is required by the TSS, and ignoring other parts.

2.5 Outcall Billing Records

The Outcall Billing Records is an optional package that is site specifically tailored to the interpretation of records from the TSS passed to the Billing System, to enable the Message Optimiser to interpret activity on the TSS that is not traceable via normal call handling (i.e. TSS originated calls).

2.6 Report Request

The Report Request package outlines the requests to the Report Manager required to support generation and viewing of reports provided by the Message Optimiser.

2.7 Configuration Data

The Configuration Data package defines the data that is added to the database from the administrator for various administrative and configuration tasks.

2.8 Configuration Trigger

The Configuration Trigger package outlines the interactions necessary to signal the Message Optimiser that configuration data has changed, and that a reload of such information is necessary.

2.9 Service Deletion

The Service Deletion package defines the interactions necessary to tidy up telephony services on the TSS.

2.10 Administration Requests

The Administration Requests package defines the interactions between the Administrator and Admin Manager required to configure the Message Optimiser.

2.11 Data Extraction

The Data Extraction package defines the interaction necessary with the Message Optimiser Database to extract the information required to create the reports provided by the Report Manager.

2.12 Configuration Request

The Configuration Request package outlines the interactions with the database necessary to extract configuration details required to run the Message Optimiser.

Throughout this specification the following abbreviations have been used:
CDR Call Detail Record
MO Message Optimiser
MSC Mobile Switching Centre
TSS Telephony Service System
VMS Voice Mail System

It should be understood that the above description is of a preferred embodiment and provided by way of illustration only. Clearly a person skilled in the art would understand variations to the invention without any inventive element and such are included within the scope of the invention as defined in the following claims.

1. A method of automatically allocating a mailbox to a called party in a digital telephone network, including the steps: receiving a call to be routed to a called party; extracting one or more relevant predefined parameters from the call; using one or more of the extracted parameters to determine the existence of a mailbox associated with the called party; if an associated mailbox exists, translating the call to that mailbox address; if there is not a mailbox number associated with the called party, allocating a mailbox from a pre-existing pool of mailboxes available for allocation to the called party; diverting the call to the allocated mailbox.

2. A method according to claim 1 including the steps: receiving a call to be routed to a called party; extracting one or more relevant predefined parameters from the call to identify the nature of the caller and the nature of the called destination including the called party's telephone number; using one or more of the extracted parameters to examine a database, archive, information listing or the like to determine the existence of mailbox identifier associated with the called party; if an associated mailbox exists, translating the called number to that mailbox address; if the database does not contain a mailbox identifier associated with the called number, allocating a mailbox from a pre-existing pool of mailboxes available for allocation to the called party's telephone number; diverting the call to the allocated mailbox; notifying the called party of the waiting message.

3. A method according to claim 1 including the step of deleting the contents of the mailbox, de-allocating the mailbox and returning it to the pool of mailboxes available for allocation on the occurrence of any one of following events: no message deposits and message retrievals have been made within a pre-defined period; or no message deposits have been made within a pre-defined period; or no message retrievals have been made within a pre-defined period.

4. A method of maintaining a pool of mailboxes available for allocation, deallocation and re-allocation, and thereby minimising the amount of required storage space for the said pool, including the steps: at a predetermined time frequency, scanning a database of mailbox allocation and usage records; from those records, detecting an allocated mailbox and determining its last usage time; if the last usage time exceeds a predetermined period, deleting the contents of the mailbox and marking the mailbox as free for re-allocation; continuing until all mailbox records have been scanned at which time the process is suspended until it conducts another cycle at the said predetermined time frequency.

5. A method of dynamically allocating a mailbox to a called party in a digital telephone network, comprising the following steps: receiving a call to be routed to a called party; extracting relevant/predefined parameters from the message; examining l inspecting a database as to the existence of an associated mailbox number translating the called number to a mailbox address, if available or, in the event that the called party does not have a mailbox/the database does not contain a mailbox number associated with the called number, assigning a mailbox to the called party telephone number; diverting the call to the allocated mailbox.

6. A method according to claim 5 in which the mailbox is allocated from a preexisting pool of mailboxes.

7. A method according to claim 5 in which the called party is identified by a digital network telephone number/telephony network identifier.

8. A method according to claim 5 in which the mailbox is identified by an identification number.

9. A method according to claim 8 in which the method of automatically associating a telephony network g the steps: at a predetermined time frequency, scanning a database of mailbox allocation and usage records; from those records, detecting an allocated mailbox and determining its last usage time; if the last usage time exceeds a predetermined period, deleting the contents of the mailbox and marking the mailbox as free for re-allocation; continuing until all mailbox records have been scanned at which time the process is suspended until it conducts another cycle at the said predetermined time frequency.

10. A method according to claim 9 in which the method of the automatic association allocation process can be initiated in any one of the following events: the called party does not answer the call; the called mobile network subscriber/party does not have a mailbox; the call does not originate from the called party.

11. A method according to claim 5 including the step of deleting the contents of the mailbox and de-allocating the mailbox on the occurrence of any one of following events: no message deposits and message retrievals have been made within a pre-defined period; or no message deposits have been made within a pre-defined period; or no message retrievals have been made within a pre-defined period.

12. A method according to claim 11 including the step of de-associating the mailbox from the subscriber identifier on the occurrence of any one of following events: no message deposits and message retrievals have been made within a pre-defined period; or no message deposits have been made within a pre-defined period; or no message retrievals have been made within a pre-defined period.

13. A method according to claim 11 including the step of returning the de-allocated mailbox to the pool of mailboxes available for re-allocation.

14. A method according to claim 13 in which the re-allocating of the mailbox can be to a new mobile network subscriber upon the occurrence of any one of following events: no message deposits and message retrievals have been made within a pre-defined period; or no message deposits have been made within a pre-defined period; or no message
